(19) United States
(12) Patent Application Publication
(10) Pub. No.: US 2005/0024657 A1
(43) Pub. Date: Feb. 3, 2005

(54) Color chart

(75) Inventors: Noriko Ota, Saitama (JP); Shunichi Ito, Tokyo (JP); Nobuaki Abe, Saitama (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/898,959

(22) Filed: Jul. 27, 2004

(30) Foreign Application Priority Data
Jul. 28, 2003 (JP) P2003-202256
Oct. 23, 2003 (JP) P2003-363663

(51) Int. Cl. H04N 1/50; H04N 1/60; H04N 1/58

(52) U.S. Cl. 358/1.9; 358/527; 358/519; 358/532; 358/521; 358/504; 348/71

(57) ABSTRACT

A color chart for a color adjustment of a color printer and a color monitor attached to an endoscope, has first-, second-, and third-color cell groups. The first-, second-, and third-color cell groups have respective first, second, and third predetermined numbers of color cells which have the same form, and which are linearly arranged in a first direction. The first-, second-, and third-color cell groups are arranged in a second direction which is perpendicular to the first direction.

### BACKGROUND OF THE INVENTION

1. Field of the Invention

The present invention relates to an endoscope and in particular to an apparatus for the color adjustment of a color printer and a color monitor connected to the endoscope.

2. Description of the Related Art

Endoscopes are used widely in the field of medicine, especially for the observation and the inspection of the inside of an organ. Such endoscopes consist of a color scope, a color processing unit, a color printer, and a color monitor. The color scope images a subject and is controlled by the color processing unit. The electric signals obtained during the imaging process are converted to image-signals by the processing unit and are then output to the color printer and the color monitor. The converted image-signals are analogue signals and are supplied to the color printer and the color monitor. The supplied image-signals can be converted to a hard copy, in other words printed out by the color printer, and kept as a soft copy, in other words stored in a memory and indicated on a color monitor.

The endoscope is used for the observation and the inspection of the inside of an organ. Accordingly, it is desirable that the color tone of the output images which are imaged by an endoscope, resemble as much as possible the real color of the photographic subject. It is desirable that the color tone of the output image by the color printer resemble the color tone of the output image by the color monitor.

Each component of an endoscope has a color reappearance range or a color imaging range which differs. A color adjustment method which takes into consideration the color range of each component is needed.

Japanese unexamined patent publication (KOKAI) No. 08-152566 discloses a method for the color adjustment of a color scope, a color processing unit, and a color monitor, by using a color chart. This invention discloses a method for the color adjustment of the color scope which is an imaging apparatus, and the color monitor which is an output apparatus.

However, the above disclosed method does not disclose a method for the color adjustment of the color printer and the color monitor which are output devices.

### SUMMARY OF THE INVENTION

The color printer produces colors by overlaying yellow, magenta, and cyan which are the alternative three primaries, according to a predetermined ratio. The color monitor produces colors by mixing red, green, and blue which are the primaries, according to a predetermined ratio. The color printer has a color range different from that of the color monitor (see FIG. 1).

For the color adjustment of the color printer and the color monitor, it is necessary to adjust seven adjustment parameters.

The first adjustment parameter is a red adjustment parameter which is for the adjustment of the cyan and red complementary color relationship. The second adjustment parameter is a green adjustment parameter which is for the adjustment of the magenta and green complementary color relationship. The third adjustment parameter is a blue adjustment parameter which is for the adjustment of the yellow and blue complementary color relationship.

The fourth adjustment parameter is a darkness adjustment parameter which is for the adjustment of the gradation of a dark part, or a contrast of shadows. The fifth adjustment parameter is a brightness adjustment parameter which is for the adjustment of the gradation of a bright part, or a contrast of highlights. The sixth adjustment parameter is a sharpness adjustment parameter which is for adjusting image quality. The seventh adjustment parameter is a gamma adjustment parameter which is for a gamma correction.

Adjusting seven adjustment parameters is difficult, because colors are different between a color printer and a color monitor, and color ranges are different between a color printer and a color monitor.

The connections between a color processing unit, a color printer, and a color monitor are usually analogue connections, because of the requirement for exchangeability of different apparatus having different manufacturers. It is not possible to carry out the adjustment of seven adjustment parameters automatically, unlike for PC's etc. which are able to connect by digital signals, as well as analogue signals.

Accordingly, the operator of the endoscope has to carry out the color adjustment of about seven adjustment parameters. An objective method has not been established yet. The conventional method is to manually compare the output image by the color printer and the output image on the color monitor, which were imaged by the operator using the color scope. Devices such as color printers etc., have fourteen adjustment levels, so that it is necessary to select the optimal parameter from 7×14 combinations, in the color adjustment process.

The color tone of the color printer and also the color monitor changes with the passing of time for each apparatus. Accordingly, strictly, it is necessary to carry out the color adjustment of the above parameters whenever the endoscope is used. At least, it is necessary to carry out the color adjustment of the above parameters at the time the printer ribbon is changed.

Therefore, an object of the present invention is to provide a device that can carry out the color adjustment of the color printer and the color monitor accurately and objectively, where the connections are analogue signal connections.

According to the present invention, a color chart for a color adjustment of a color printer and a color monitor attached to an endoscope, comprises a first-color cell group, a second-color cell group, and a third-color cell group. The color cell groups have respective first, second, and third predetermined numbers of color cells having the same form, and the color cells within each of said color cell group are linearly arranged in a first direction.

The first-, second-, and third-color cell groups are arranged in a second direction which is perpendicular to the first direction.

Each of the color cells, which form the first-color cell group, the second-color cell group, and the third-color cell group, is formed by blending three colors comprising red, green, and blue, according to predetermined ratios, in an additive color process. Further each color cell shows a gradation of color such that a ratio one of the colors in each of the color cells increases continuously in the first direction within each color cell group, and ratios of the respective remaining two of said colors in each of the color cells within each color cell group, decrease continuously and in the same proportion in said first direction.

### BRIEF DESCRIPTION OF THE DRAWINGS

The objects and advantages of the present invention will be better understood from the following description, with reference to the accompanying drawings in which:

FIG. 1 is a chromaticity diagram which shows the difference in color range between a color printer and a color monitor;

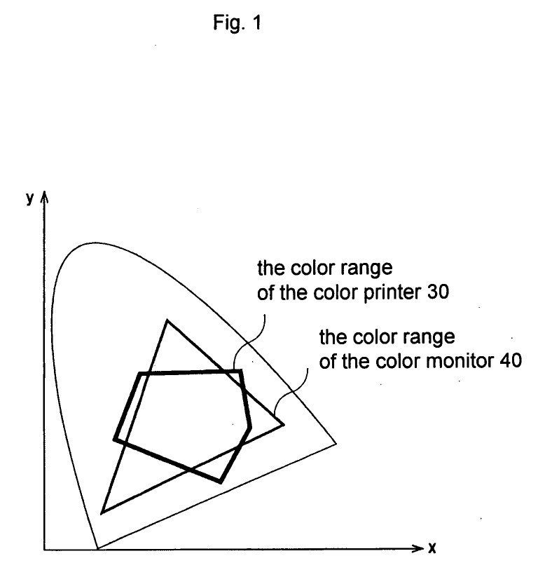

FIG. 2 is a block diagram of an endoscope;

FIG. 3 is a front view of a color adjustment apparatus;

FIG. 4 is a plane view of a screen pattern;

FIG. 5 is a plane view of a first color chart;

FIG. 6 is a plane view of a second color chart;

FIG. 7 is a plane view of a third color chart;

FIG. 8 is a plane view of a fourth color chart; and

FIG. 9 is a plane view of a fifth color chart;

### DESCRIPTION OF THE PREFERRED EMBODIMENTS

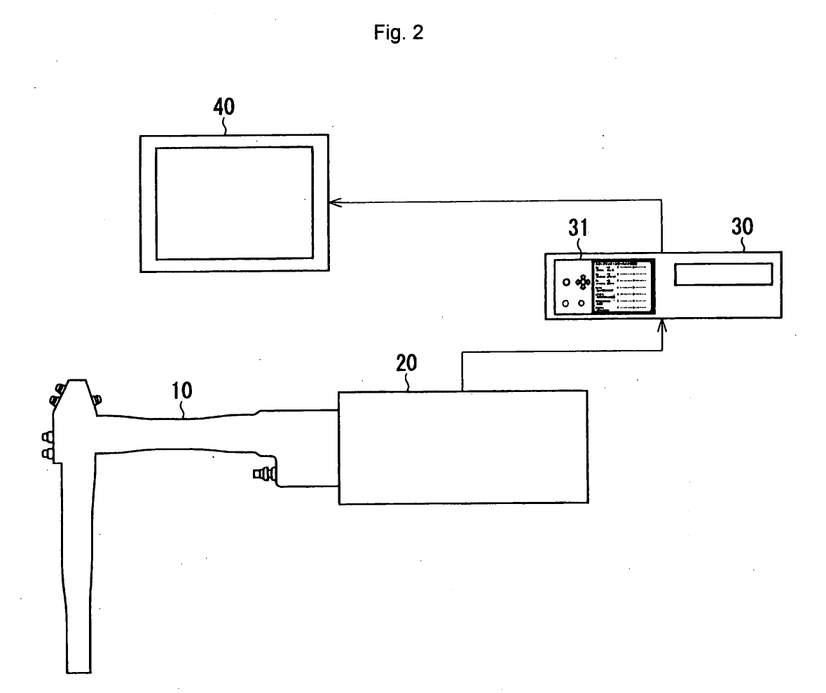

The present invention is described below with reference to the embodiments shown in the drawings. As shown in FIG. 2, an endoscope relating to a first embodiment is provided with a color scope 10, a color processing unit 20, a color printer 30, and a color monitor 40. The color scope 10 images a subject and is controlled by the color processing unit 20. The electric signals obtained during the imaging process are converted to image-signals by the processing unit 20 and are then output to the color printer 30 and displayed on the color monitor 40. The converted image-signals are analogue signals and are supplied to the color printer 30 and the color monitor 40. The supplied image-signals can be converted to a hard copy, in other words printed out by the color printer 30, and kept as a soft copy, in other words stored in a memory and indicated on a color monitor 40. An operator can observe the photographic subject that was imaged with the color scope 10 as a first output image by the color printer 30, and as a second output image by the color monitor 40.

The color scope 10 has an imaging unit, a lighting unit, and so on. The imaging unit has an imaging device such as a CCD which is not depicted. The lighting unit has a lighting lens system for illuminating the photographic subject, for example inside a dark interior hollow of an organ. The lighting unit supplies appropriate light to the photographic subject. The imaging unit images the photographic subject and then converts the image to electric signals.

The color processing unit 20 has a signal processing section such as DSP and so on, which is not depicted. The color processing unit 20 converts electric signals of an image which was imaged by the color scope 10, to image-signals which can be output to the color printer 30 and also the color monitor 40, and supplies the image signals to the color printer 30 and also the color monitor 40. Further, the color processing unit 20 has a light source which is not depicted, so that the color processing unit 20 supplies light through a light guidance system to the lighting lens system which is located in the tip of the color scope 10.

The color printer 30 is a printer which can read analogue image-signals. The color printer 30 adjusts the image-signals which were imaged by the color scope 10, and converted and supplied by the color processing unit 20, with a color adjustment parameter of the color printer 30, so that the color printer 30 produces an accurate hard copy (print out). Further, the image-signals supplied to the color printer 30 are supplied to the color monitor 40 without adjustment. Therefore, the signals sent to color monitor 40 are not influenced by the color adjustment parameter of the color printer 30.

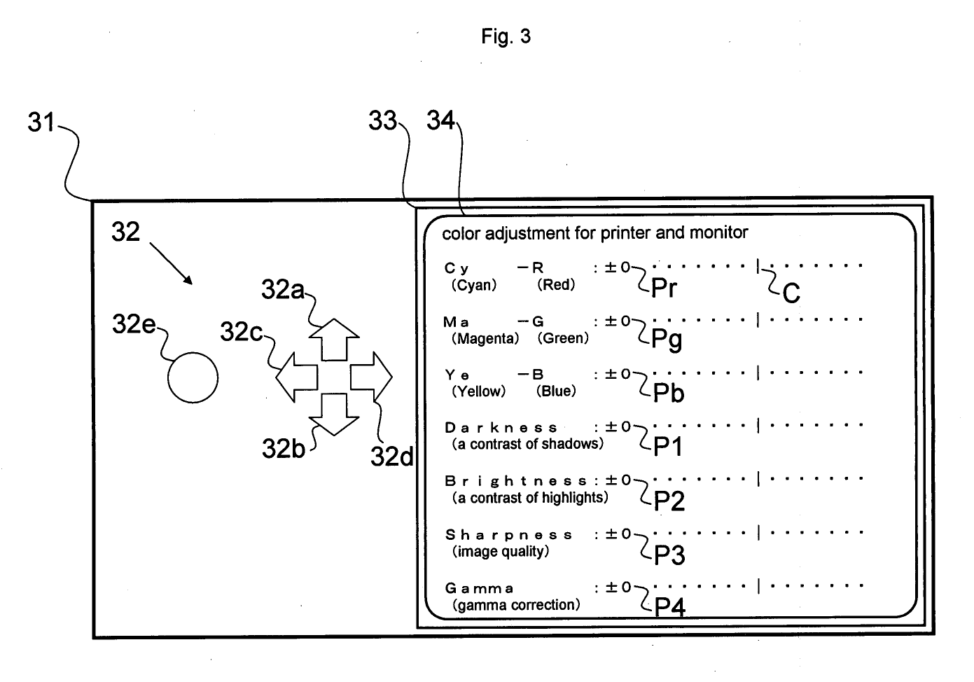

Further, the color printer 30 has a color adjustment apparatus 31. The color adjustment apparatus 31 combines the color tone of the first output image by the color printer 30 and the second output image by the color monitor 40 by an operation of the operator. The color adjustment apparatus 31 has a color adjustment operation unit 32, and a color adjustment indicating unit 33. The color adjustment is carried out by operating the color adjustment apparatus 31 and by observing a first color chart 51 or a second color chart 52 on the color adjustment indicating unit 33. The first and second color charts 51 and 52 are described later. The color adjustment apparatus 31 has other keys which are not depicted. FIG. 3 shows the color adjustment apparatus 31 of the color printer 30, in detail.

The color adjustment operation unit 32 has direction keys 32a, 32b, 32c, and 32d, and a decision key 32e. The keys 32a, 32b, 32c, and 32d are used to control the movement of a cursor C on a color adjustment screen of the color adjustment indicating unit 33, while key 32e is used to select the input operation when the color adjustment is done (see FIG. 3).

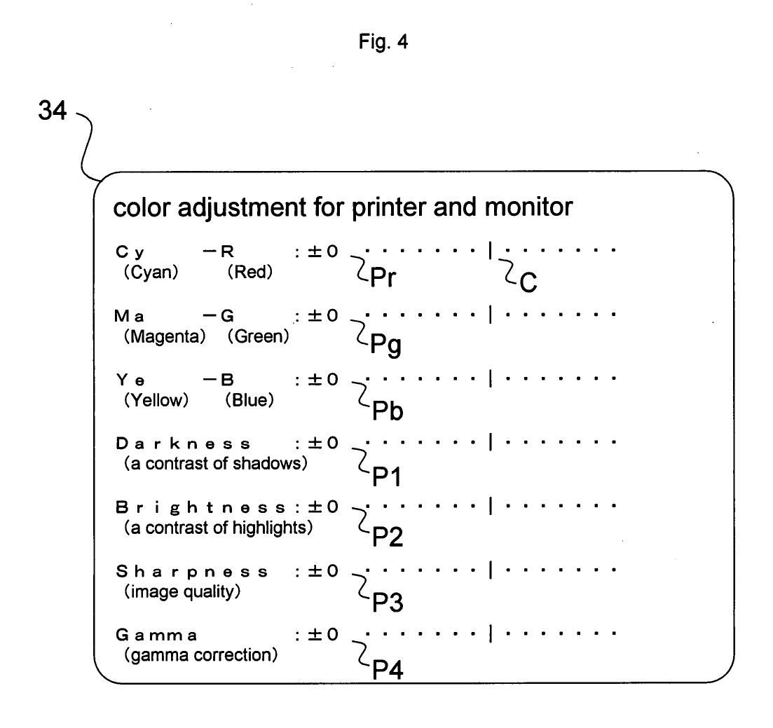

The color adjustment indicating unit 33 has an indicating device, such as an LCD etc, so that the color adjustment indicating unit 33 can have an adjusting screen pattern 34 indicated there on. (see FIG. 4) The adjusting screen pattern 34 indicates all seven adjustment parameters and seven adjustment items, so that all the parameters can be adjusted.

A red adjustment parameter Pr is for the adjustment of the cyan and red complementary color relationship, so that a first adjustment item is “Cy (Cyan)-R (Red)”.

A green adjustment parameter Pg is for the adjustment of the magenta and green complementary color relationship, so that a second adjustment item is “Mg (Magenta)-G (Green)”.

A blue adjustment parameter Pb is for the adjustment of the yellow and blue complementary color relationship, so that a third adjustment item is “Ye (Yellow)-B (Blue)”.

A darkness adjustment parameter P1 is for the adjustment of the gradation of a dark part, or a contrast of shadows, so that a fourth adjustment item is “Darkness (a contrast of shadows)”. The adjustment of the contrast of shadows helps reveal details hidden in the shadows, and compensates for underexposure.

A brightness adjustment parameter P2 is for the adjustment of the gradation of a bright part or a contrast of highlights, so that a fifth adjustment item is “Brightness (a contrast of highlights)”. The adjustment of the contrast of highlights helps reveal details hidden in the highlights, and compensates for overexposure.

A sharpness adjustment parameter P3 is for adjusting image quality, so that a sixth adjustment item is “Sharpness”.

A gamma adjustment parameter P4 is for a gamma correction, so that a seventh adjustment item is “Gamma correction”.

All the parameters can be adjusted by moving the cursor C on the screen by operating the direction keys 32a, 32b, 32c, and 32d, and the decision key 32e.

The operator selects one of the color-adjustment items on the adjusting screen pattern 34 by operating the top and bottom direction keys 32a and 32b of the direction keys 32a, 32b, 32c, and 32d that are on the color adjustment apparatus 31 (see FIG. 4), then the operator operates the selection key 34f. The color of the letter of the color-adjustment item, corresponding to the cursor C location, differs from the color of the letters of other color-adjustment items, which are not depicted. Accordingly, it is easy to understand which color-adjustment item is selected. The value of the selected adjustment parameter can be changed by operating the left and right direction keys 32c and 32d and also the decision key 32e.

Furthermore, in the first embodiment, the red adjustment parameter Pr which is set up as the first adjustment item, shows a change in value from the prescribed standard output value of the red primary color signal.

Similarly, the green adjustment parameter Pg which is set up as the second adjustment item, shows the change in value from the prescribed standard output value of the green primary color signal.

Similarly, the blue adjustment parameter Pb which is set up as the third adjustment item, shows the change in value from the prescribed standard output value of the blue primary color signal.

When the cursor C on the color adjustment indicating unit 33, is moved toward the primary color position (right direction in FIG. 4) from the standard position which is located at almost the center of the moving range (see FIG. 4) by operating the left and right direction keys 32c and 32d, the values of the parameters Pr, Pg, and Pb are increased. When the cursor C is moved toward the complementary color position (left direction in FIG. 4), the values of the parameters Pr, Pg, and Pb are decreased.

Similarly, when the cursor C is moved toward the right direction in FIG. 4, the value of the darkness adjustment parameter P1 is increased, so that a gradation of a dark part (a low lightness part) or a contrast of shadows is strengthened. When the cursor C is moved toward the left direction in FIG. 4, the value of the darkness adjustment parameter P1 is decreased, so that a gradation of a dark part or a contrast of shadows is weakened.

Similarly, when the cursor C is moved toward the right direction in FIG. 4, the value of the brightness adjustment parameter P2 is increased, so that a gradation of a bright part (a high lightness part) or a contrast of highlights is strengthened. When the cursor C is moved toward the left direction in FIG. 4, the value of the brightness adjustment parameter P2 is decreased, so that a gradation of a bright part (a high lightness part) is weakened.

Similarly, when the cursor C is moved toward the right direction in FIG. 4, the value of the sharpness adjustment parameter P3 is increased, so that a ratio of outline emphasis is strengthened. When the cursor C is moved toward the left direction in FIG. 4, the value of the sharpness adjustment parameter P3 is decreased, so that a ratio of outline emphasis is weakened.

Similarly, when the cursor C is moved toward the right direction in FIG. 4, the value of the gamma adjustment parameter P4 is increased, so that an area which is output darkly is increased (hard gradation). When the cursor C is moved toward the left direction in FIG. 4, the value of the gamma adjustment parameter P4 is decreased, so that an area which is output whitely is increased (soft gradation).

For example, the value of the red adjustment parameter Pr which is the first adjustment item, “Cy (Cyan)-R (Red)”, changes to plus 1, when the position of the cursor C is moved 1 graduation toward the red primary color, from the standard position. Similarly, the value of the red adjustment parameter Pr changes to minus 1, when the position of the cursor C is moved 1 graduation toward the cyan complementary color, from the standard position. A similar relationship holds for the green adjustment parameter Pg which is the second adjustment item, “Mg (Magenta)-G (Green)”; the blue adjustment parameter Pb which is the third adjustment item, “Ye (Yellow)-B (Blue)”; the darkness adjustment parameter P1 which is the fourth adjustment item, “Darkness (a contrast of shadows)”; the brightness adjustment parameter P2 which is the fifth adjustment item, “Brightness (a contrast of highlights)”; the sharpness adjustment parameter P3 which is the sixth adjustment item, “Sharpness (image quality)”; and the gamma adjustment parameter P4 which is the seventh adjustment item, “Gamma (gamma correction)”.

The color monitor 40 is a typical monitor that is available in the market, and that can indicate images based on analogue image-signals. The color monitor 40 can indicate images based on image-signals of an object, which is imaged by the color scope 10, that have been converted to analogue signals by the color processing unit 20 and supplied there by, via the color printer 30, to the color monitor 40, so that the color monitor 40 indicates the images.

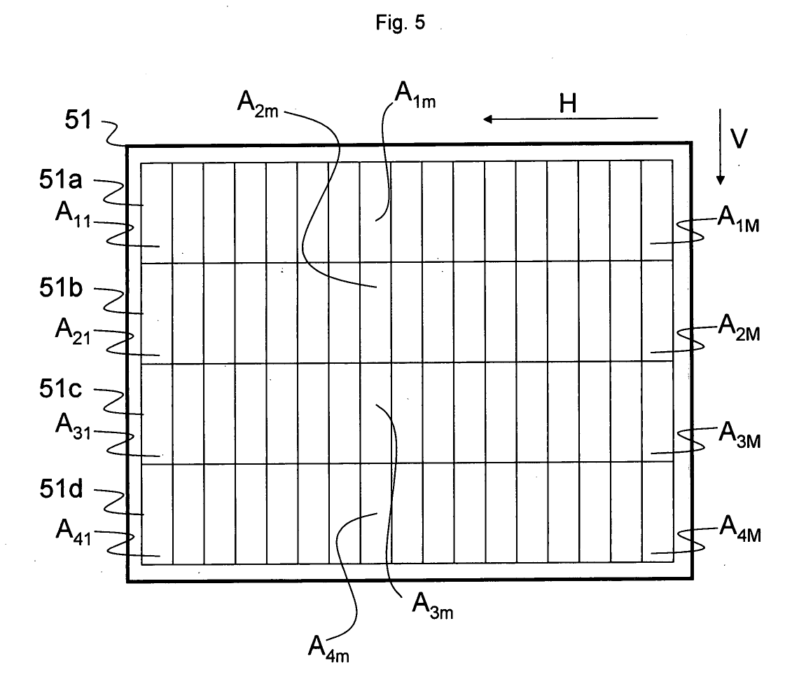

FIG. 5 shows the first color chart 51 for the color adjustment of the color printer 30 and the color monitor 40.

In the first embodiment, a first direction is defined as a left direction in FIG. 5 (“H” arrow direction in FIG. 5), and a second direction is defined as a down direction in FIG. 5 (“V” arrow direction in FIG. 5). The first direction crosses the second direction.

The first color chart 51 comprises first-, second-, third-, and fourth-color cell groups 51a, 51b, 51c, and 51d.

The first-color cell group 51a has a first predetermined number of color cells which have a same form and are arranged in a linear state, and in the first direction.

The second-color cell group 51b has a second predetermined number of color cells which have the same form and are arranged in the linear state, and in the first direction.

The third-color cell group 51c has a third predetermined number of color cells which have the same form and are arranged in the linear state, and in the first direction.

The fourth-color cell group 51d has a fourth predetermined number of color cells which have the same form and are arranged in the linear state, and in the first direction.

Each of the color cells which form the first-color cell group 51a, is formed by blending three colors comprising red, green, and blue, according to a predetermined ratio, in an additive color process.

Each of the color cells which form the first-color cell group 51a, shows a gradation of color such that, a red blending ratio of each of the color cells increases continuously, and proportionally in each of the color cells in the first direction, and green and blue blending ratios of each of the color cells decrease continuously and in the same proportion in each of the color cells in the first direction.

Specifically, for example, in FIG. 5, the color cell at the left edge of the first-color cell group 51a is red, that is, it has red 100%, green 0%, and blue 0%, and the color cell at the right edge of the first-color cell group 51a is cyan, that is, it has red 0%, green 100%, and blue 100%. Regarding the change of the color tone in each of the color cells, the red strength increases in the left direction (the first direction) according to a predetermined ratio, and the cyan strength decreases in the left direction (the first direction) according to the predetermined ratio.

Each of the color cells which form the second-color cell group 51b, is formed by blending three colors comprising red, green, and blue, according to a predetermined ratio, in an additive color process.

Each of the color cells which form the second-color cell group 51b, shows a gradation of color such that a green blending ratio of each of the color cells increases continuously and proportionally in each of the color cells in the first direction, and red and blue blending ratios of each of the color cells decreases continuously and proportionally in each of the color cells in the first direction.

Specifically, for example, in FIG. 5, the color cell at the left edge of the second-color cell group 51b is green, that is, it has red 0%, green 100%, and blue 0%, and the color cell at the right edge of the second-color cell group 51b is magenta, that is, it has red 100%, green 0%, and blue 100%. Regarding the change of the color tone in each of the color cells, the green strength increases in the left direction (the first direction) according to a predetermined ratio, and the magenta strength decreases in the left direction (the first direction) according to the predetermined ratio.

Each of the color cells which form the third-color cell group 51c, is formed by blending three colors comprising red, green, and blue, according to a predetermined ratio, in an additive color process.

Each of the color cells which form the third-color cell group 51c, shows a gradation of color such that a blue blending ratio of each of the color cells increases continuously and proportionally in each of the color cells in the first direction, and red and green blending ratios of each of the color cells decrease continuously and proportionally in each of the color cells in the first direction.

Specifically, for example, in FIG. 5, the color cell at the left edge of the third-color cell group 51c is blue, that is, it has red 0%, green 0%, and blue 100%, and the color cell at the right edge of the third-color cell group 51c is yellow, that is, it has red 100%, green 100%, and blue 0%. Regarding the change of the color tone in each of the color cells, the blue strength increases in the left direction (the first direction) according to a predetermined ratio, and the yellow strength decreases in the left direction (the first direction) according to the predetermined ratio.

Each of the color cells which form the fourth-color cell group 51d, is formed by blending two colors comprising black, and white, according to a predetermined ratio, in other words, is formed by blending three colors comprising red, green, and blue, according to a predetermined ratio, in an additive color process.

Each of the color cells which form the fourth-color cell group 51d, shows a gradation of lightness such that a white blending ratio of each of the color cells increases continuously in each of the color cells in the first direction, and black blending ratio of each of the color cells decreases continuously in each of the color cells in the first direction.

Or, each of the color cells which form the fourth-color cell group 51d, shows a gradation of color such that the red, green, and blue blending ratio of each of the color cells increase continuously and proportionally in each of the color cells in the first direction.

Specifically, for example, in FIG. 5, the color cell at the left edge of the fourth-color cell group 51d is white, that is, it has red 100%, green 100%, and blue 100%, and the color cell at the right edge of the fourth-color cell group 51d is black, that is, it has red 0%, green 0%, and blue 0%. Regarding the change of the lightness in each of the color cells, the white strength increases in the left direction (the first direction) according to a predetermined ratio, and the black strength decreases in the left direction (the first direction) according to the predetermined ratio.

The size of the first color chart 51 is set so that all of the first color chart 51 can be imaged by the color scope 10, when the first color chart 51 is arranged at a similar distance that a photographic subject would be imaged at, in for example an interior hollow of an organ.

The first-color cell group 51a is a matrix of one row and M columns, so that 1×M color cells are arranged in the first-color cell group 51a. The second-color cell group 51b is a matrix of one row and M columns, so that 1×M color cells are arranged in the second-color cell group 51b. The third-color cell group 51c is a matrix of one row and M columns, so that 1×M color cells are arranged in the third-color cell group 51c. The fourth-color cell group 51d is a matrix of one row and M columns, so that 1×M color cells are arranged in the fourth-color cell group 51d.

M is a natural number. If the numerical value of M is large, the changes in gradation of the first-, second-, third-, and fourth-color cell groups 51a, 51b, 51c, and 51d will be smooth.

The color cells in all of the color cell groups 51a, 51b, 51c, and 51d have the same rectangular form. The outer layers of the first-, second-, third-, and fourth-color cell groups 51a, 51b, 51c, and 51d have the same form. Or, the outer layers of the first-, second-, third-, and fourth-color cell groups 51a, 51b, 51c, and 51d have the same length in the first direction, and the same length in the second direction. The first, second, third, and fourth predetermined numbers are the same.

The first-color cell group 51a has a first left side cell at the left side of the first-color cell group 51a, and first right side cell at the right side of the first-color cell group 51a.

The position of the first left side cell is defined as A₁₁. In other words, A₁₁ is located in the first column, that is, it is located at the left side of the first-color cell group 51a.

The color cell A₁₂ is one column to the right of A₁₁. The color cell A₁ₘ is (m-1) columns to the right of A₁₁. The color cell A_{1M} is (M-1) columns to the right of A₁₁, in other words, A_{1M} is located at the right side of the first-color cell group 51a. Or, the position of the first right side cell is defined as A_{1M}.

The second-color cell group 51b has a second left side cell at the left side of the second-color cell group 51b, and second right side cell at the right side of the second-color cell group 51b.

The position of the second left side cell is defined as A₂₁. In other words, A₂₁ is located in the first column, that is, it is located at the left side of the second-color cell group 51b.

The color cell A₂₂ is one column to the right of A₂₁. The color cell A₂ₘ is (m-1) columns to the right of A₂₁. The color cell A2M is (M-1) columns to the right of A₂₁, in other words, A_{2M} is located at the right side of the second-color cell group 51b. Or, the position of the second right side cell is defined as A_{2M}.

The third-color cell group 51c has a third left side cell at the left side of the third-color cell group 51c, and third right side cell at the right side of the third-color cell group 51c.

The position of the third left side cell is defined as A₃₁. In other words, A₃₁ is located in the first column, that is, it is located at the left side of the third-color cell group 51c.

The color cell A₃₂ is one column to the right of A₃₁. The color cell A₃ₘ is (m-1) columns to the right of A₃₁. The color cell A_{3M} is (M-1) columns to the right of A₃₁, in other words, A_{3M} is located at the right side of the third-color cell group 51c. Or, the position of the third right side cell is defined as A_{3M}.

The fourth-color cell group 51d has a fourth left side cell at the left side of the fourth-color cell group 51d, and fourth right side cell at the right side of the fourth-color cell group 51d.

The position of the fourth left side cell is defined as A₄₁. In other words, A₄₁ is located in the first column, that is, it is located at the left side of the fourth-color cell group 51d.

The color cell A₄₂ is one column to the right of A₄₁. The color cell A₄ₘ is (m-1) columns to the right of A₄₁. The color cell A_{4M} is (M-1) columns to the right of A₄₁, in other words, A_{4M} is located at the right side of the fourth-color cell group 51d. Or, the position of the fourth right side cell is defined as A_{4M}.

In the first-color cell group 51a, the 1×M cells have red, green, and blue which are the three primaries, blended in accordance with a predetermined ratio, and are arranged in accordance with a standard arrangement.

In the second-color cell group 51b, the 1×M cells have red, green, and blue which are the three primaries, blended in accordance with a predetermined ratio, and are arranged in accordance with a standard arrangement.

In the third-color cell group 51c, the 1×M cells have red, green, and blue which are the three primaries, blended in accordance with a predetermined ratio, and are arranged in accordance with a standard arrangement.

In the fourth-color cell group 51d, the 1×M cells have red, green, and blue which are the three primaries, blended in accordance with a predetermined ratio, and are arranged in accordance with a standard arrangement.

Specifically, the color cell having red {100×(m-1)÷(M-1)}%, green {100×(m-1)÷(1-M)+100}%, and blue {100×(m-1)÷(1-M)+100}% is A₁ₘ. The color cell having red 0%, green 100%, and blue 100% or the cyan cell, is arranged at A₁₁. The color cell having red 100%, green 0%, and blue 0% or the red cell, is arranged at A_{1M}. In this case, the first-color cell group 51a is a gradation arrangement of red, and cyan.

The color cell having red {100×(m-1)÷(1-M)+100}%, green {100×(m-1)÷(M-1)}%, and blue {100×(m-1)÷(1-M)+100}% is A₂ₘ. The color cell having red 100%, green 0%, and blue 100% or the magenta cell, is arranged at A₂₁. The color cell having red 0%, green 100%, and blue 0% or the green cell, is arranged at A_{2M}. In this case, the second-color cell group 51b is a gradation arrangement of green, and magenta.

The color cell having red {100×(m-1)÷(1-M)+100}%, green {100×(m-1)÷(1-M)+100}%, and blue {100×(m-1)÷(M-1)}% is A₃ₘ. The color cell having red 100%, green 100%, and blue 0% or the yellow cell, is arranged at A₃₁. The color cell having red 0%, green 0%, and blue 100% or the blue cell, is arranged at A_{3M}. In this case, the third-color cell group 51c is a gradation arrangement of blue, and yellow.

The color cell having red {100×(m-1)×(M-1)}% green {100×(m-1)÷(M-1)}%, and blue {100×(m-1)÷(M-1)}% is A₄ₘ. The color cell having red 0%, green 0%, and blue 0% or the black cell, is arranged at A₄₁. The color cell having red 100%, green 100%, and blue 100% or the white cell, is arranged at A_{4M}. In this case, the fourth-color cell group 51d is a gradation arrangement of black and white, in other words, a gray scale.

If the numerical value of M is an odd number, the color cell which is positioned in the middle of the first-color cell group 51a, is gray, having red 50%, green 50%, and blue 50%. Similarly, the color cell which is positioned in the middle of the second-color cell group 51b, is gray, having red 50%, green 50%, and blue 50%. The color cell which is positioned in the middle of the third-color cell group 51c, is gray, having red 50%, green 50%, and blue 50%. The color cell which is positioned in the middle of the fourth-color cell group 51d, is gray, having red 50%, green 50%, and blue 50%.

The first-color cell group 51a, the second-color cell group 51b, the third-color cell group 51c, and the fourth-color cell group 51d are arranged in this order in the second direction.

Each color cell which forms the first-color cell group 51a, each color cell which forms the second-color cell group 51b, each color cell which forms the third-color cell group 51c, and each color cell which forms the fourth-color cell group 51d has the same form in the first embodiment.

The color adjustment of the color printer 30 and the color monitor 40 using the first color chart 51 will be explained, for the first embodiment. The color adjustment of the first embodiment has first, second, third, fourth, fifth, sixth, and seventh processes. In the first process, the red strength is judged. In the second process, the green strength is judged. In the third process, the blue strength is judged. In the fourth process, a contrast of shadows is judged. In the fifth process, a contrast of highlights is judged. In the sixth process, image quality is judged. In the seventh process, gamma correction is judged.

First of all, the first color chart 51 is imaged by the color scope 10. It is desirable that the imaging conditions in the interior hollow of an organ and the imaging conditions for imaging the first color chart 51, be the same. Specifically, the first color chart 51 is imaged using only the light which is led from the light source of the color processing unit 20, without the influence of other light. Electric signals imaged by the color scope 10 are converted by the color processing unit 20, to the image-signals which can be used by the color printer 30 and the color monitor 40, so that the image-signals are supplied to the color printer 30 and the color monitor 40 by the color processing unit 20. The supplied image-signals are printed out by the color printer 30 as a hard copy of the image, and can be indicated on a screen.

The operator operates the direction keys 32a, 32b, 32c, and 32d, and the -decision-key 32e on the color adjustment apparatus 31 to indicate the adjusting screen pattern 34 which has seven adjustment parameters, on the color adjustment indicating unit 33.

The operator compares the first output image, the image of the first color chart 51 printed by the color printer 30, and the second output image, the image of the first color chart 51 displayed on the color monitor 40. The operator visually compares a first part of the first color chart 51, namely the first-color cell group 51a in the first output image, and a second part of the first color chart 51, namely the first-color cell group 51a in the second output image. The red strength is visually judged (the first process). If the operator judges that the first part is weaker than the second part regarding red strength, red is strengthened by increasing the value of the red adjustment parameter Pr. Specifically, the position of the cursor C is moved some graduations toward the red primary color by operating the direction keys 32a, 32b, 32c, and 32d, and the decision key 32e. After the value of the red adjustment parameter Pr has been changed, the operator prints out a hard copy using the color printer 30 again.

Again, the operator can compare the first output image, the image of the first color chart 51 from the color printer 30, and the second output image, the image of the first color chart 51 displayed on the color monitor 40. If the operator judges that the first part is weaker than the second part regarding red strength, red is strengthened by increasing the value of the red adjustment parameter Pr. Specifically, the position of the cursor C is moved some graduations toward the red primary color by operating the direction keys 32a, 32b, 32c, and 32d, and the decision key 32e. After the value of the red adjustment parameter Pr has been changed, the operator prints out a hard copy using the color printer 30 again. The same operations are repeated until it is visually judged that the first part and second part are equal regarding red strength.

If the operator judges that the first part is stronger than the second part regarding red strength, red is weakened by decreasing the value of the red adjustment parameter Pr. Specifically, the position of the cursor C is moved some graduations toward the cyan primary color by operating the direction keys 32a, 32b, 32c, and 32d, and the decision key 32e.

Next, the operator compares a third part regarding the second-color cell group 51b in the first output image, and a fourth part regarding the second-color cell group 51b in the second output image, without changing the red adjustment parameter Pr. The green strength is visually judged (the second process).

In the second process, the green adjustment parameter Pg is changed by moving the cursor C toward the green or magenta primary color, the first and second output images are output, the third and fourth parts are visually compared, and these operations are repeated until it is judged that the third and fourth parts are equal regarding green strength. This is similar to the first process.

Next, the operator compares a fifth part regarding the third-color cell group 51c in the first output image, and a sixth part regarding the third-color cell group 51c in the second output image, without changing the red and green adjustment parameters Pr and Pg. The blue strength is visually judged (the third process).

In the third process, the blue adjustment parameter Pb is changed by moving the cursor C toward the blue or yellow primary color, the first and second output images are output, the fifth and sixth parts are visually compared, and these operations are repeated until it is judged that the fifth and sixth parts are equal regarding blue strength. This is similar to the first and second processes.

Next, the operator compares a seventh part regarding the fourth-color cell group 51d in the first output image, and an eighth part regarding the fourth-color cell group 51d in the second output image, without changing the red, green, and blue adjustment parameters Pr, Pg, and Pb. The contrast of shadows is visually judged (the fourth process).

In the fourth process, the darkness adjustment parameter P1 is changed by moving the cursor C toward the right or left side on the adjusting screen pattern 34, the first and second output images are output, the seventh and eighth parts are visually compared regarding lightness, and these operations are repeated until it is judged that the seventh and eighth parts are equal regarding strength of the contrast of shadows. This is similar to the first, second, and third processes.

Next, the operator again compares the seventh part regarding the fourth-color cell group 51d in the first output image, and the eighth part regarding the fourth-color cell group 51d in the second output image. The contrast of shadows is visually judged (the fifth process).

In the fifth process, the brightness adjustment parameter P2 is changed by moving the cursor C toward the right or left side on the adjusting screen pattern 34, the first and second output images are output, the seventh and eighth parts are visually compared regarding lightness, and these operations are repeated until it is judged that the seventh and eighth parts are equal regarding strength of contrast of highlights. This is similar to the fourth process.

Next, the operator yet again compares the seventh part regarding the fourth-color cell group 51d in the first output image, and the eighth part regarding the fourth-color cell group 51d in the second output image. The image quality is visually judged (the sixth process).

In the sixth process, the sharpness adjustment parameter P3 is changed by moving the cursor C toward the right or left side on the adjusting screen pattern 34, the first and second output images are output, the seventh and eighth parts are visually compared regarding lightness, and these operations are repeated until it is judged that the seventh and eighth parts are equal regarding a ratio of outline emphasis. This is similar to the fourth process.

Next, the operator once more compares the seventh part regarding the fourth-color cell group 51d in the first output image, and the eighth part regarding the fourth-color cell group 51d in the second output image. The gamma correction is visually judged (the seventh process).

In the seventh and final process, the gamma adjustment parameter P4 is changed by moving the cursor C toward the right or left side on the adjusting screen pattern 34, the first and second output images are output, the seventh and eighth parts are visually compared regarding lightness, and these operations are repeated until it is judged that the seventh and eighth parts are equal regarding the width of an area which is output darkly (hard gradation). This is similar to the fourth process.

In this way, it is possible to carry out the color adjustment of the color printer 30 and the color monitor 40 of the endoscope in detail and objectively, by adjusting the seven color adjustment parameters Pr, Pg, Pb, P1, P2, P3, and P4.

Next, the second embodiment of the present invention will be explained. The structure of the endoscope is identical to that in the first embodiment. Each component in the color scope 10, the color processing unit 20, the color printer 30, and the color monitor 40 is identical to that in the first embodiment. Only the construction of the color chart is dissimilar to that in the first embodiment.

In the second embodiment, a second color chart 52 is used for the color adjustment of the color printer 30 and the color monitor 40, instead of the first color chart 51.

The second color chart 52 has fifth-, sixth-, and seventh-color cell groups 52a, 52b, and 52c.

Each color cell which forms the fifth-color cell group 52a is similar to each color cell which forms the first-color cell group 51a in the first embodiment. Accordingly, the gradation of color of the fifth-color cell group 52a is the same as that of the first-color cell group 51a in the first embodiment.

Each color cell which forms the sixth-color cell group 52b is similar to each color cell which forms the second-color cell group 51b in the first embodiment. Accordingly, the gradation of color of the sixth-color cell group 52b is the same as that of the second-color cell group 51b in the first embodiment.

Each color cell which forms the seventh-color cell group 52c is similar to each color cell which forms the third-color cell group 51c in the first embodiment. Accordingly, the gradation of color of the seventh-color cell group 52c is the same as that of the third-color cell group 51c in the first embodiment.

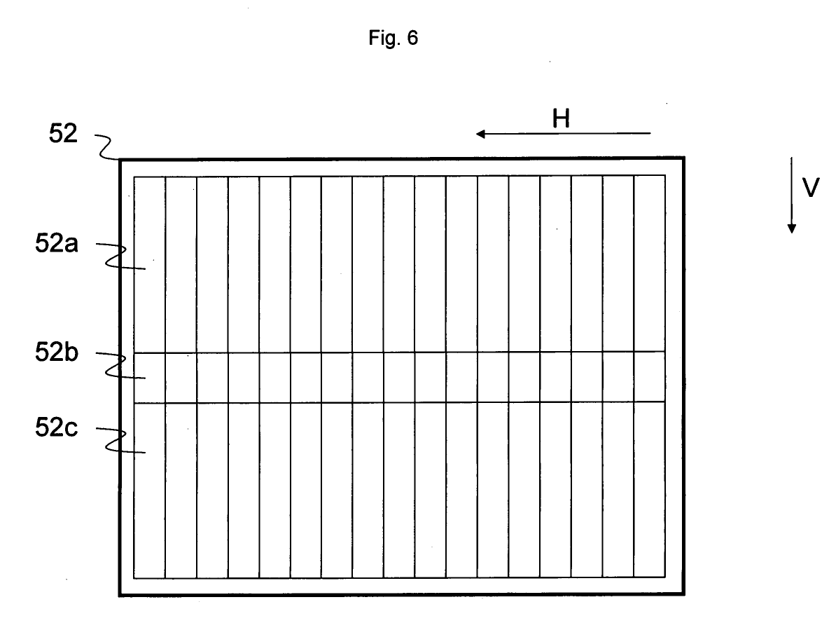

However, in the second direction, the length of the fifth-color cell group 52a, and the length of the seventh-color cell group 52c are the same, and the length of the fifth-color cell group 52a is longer than the length of the sixth-color cell group 52b, due to the priority given to each color cell group (see FIG. 6).

In the second embodiment, the priority given to adjusting the red adjustment parameter Pr is the same as the priority given to adjusting the blue adjustment parameter Pb, and the priority given to adjusting the red adjustment parameter Pr is higher than the priority given to adjusting the green adjustment parameter Pg, for the color adjustment of an endoscope used in medicine.

The fifth-color cell group 52a, the sixth-color cell group 52b, and the seventh-color cell group 52c are arranged in this order in the second direction. The sixth-color cell group 52b is arranged in the middle of the second color chart 52 in the second direction.

Because the length of sixth-color cell group 52b in the second direction is short, a part of the fifth-color cell group 52a, and a part of the seventh-color cell group 52c are arranged in the vicinity of the middle of the second color chart 52, with respect to the second direction.

The second color chart 52 is imaged by the color scope 10, similar to the first color chart 51. The imaging conditions, and the process by which the result of imaging is output to the color printer 30 and the color monitor 40, is the same as that used for the first color chart 51. However, the darkness, brightness, sharpness, and gamma adjustment parameters P1, P2, P3, and P4 are not adjusted.

The brightness of image obtained by the color scope 10, decreases in accordance with the distance from a light axis of the image optical system, due to the characteristics of the image optical system of the color scope 10, and the cos⁴ law.

The fifth-, sixth-, and seventh-color cell groups 52a, 52b, and 52c are able to be imaged without being influenced by the decrease in light quantity, in the second embodiment.

In this way, it is possible to carry out the color adjustment of the color printer 30 and the color monitor 40 of the endoscope in detail and objectively, by adjusting the three color adjustment parameters Pr, Pg, and Pb.

When the priority given to adjusting the red adjustment parameter Pr is higher than the priority given to adjusting the blue adjustment parameter Pb, the length of the fifth-color cell group 52a in the second direction may be longer than the length of the seventh-color cell group 52c in the second direction.

Next, the third embodiment of the present invention will be explained. The structure of the endoscope is identical to that in the first embodiment. Each component in the color scope 10, the color processing unit 20, the color printer 30, and the color monitor 40 is identical to that in the first embodiment. Only the construction of the color chart is dissimilar to that in the first embodiment.

In the third embodiment, a third color chart 53 is used for the color adjustment of the color printer 30 and the color monitor 40, instead of the first color chart 51.

The third color chart 53 has eighth-, ninth-, tenth-, and eleventh-color cell groups 53a, 53b, 53c, and 53d.

Each color cell which forms the eighth-color cell group 53a is similar to each color cell which forms the first-color cell group 51a in the first embodiment. Accordingly, the gradation of color of the eighth-color cell group 53a is the same as that of the first-color cell group 51a in the first embodiment.

Each color cell which forms the ninth-color cell group 53b is similar to each color cell which forms the second-color cell group 51b in the first embodiment. Accordingly, the gradation of color of the ninth-color cell group 53b is the same as that of the second-color cell group 51b in the first embodiment.

Each color cell which forms the tenth-color cell group 53c is similar to each color cell which forms the third-color cell group 51c in the first embodiment. Accordingly, the gradation of color of the tenth-color cell group 53c is the same as that of the third-color cell group 51c in the first embodiment.

Each color cell which forms the eleventh-color cell group 53d is similar to each color cell which forms the fourth-color cell group 51d in the first embodiment. Accordingly, the gradation of color of the eleventh-color cell group 53d is the same as that of the fourth-color cell group 51d in the first embodiment.

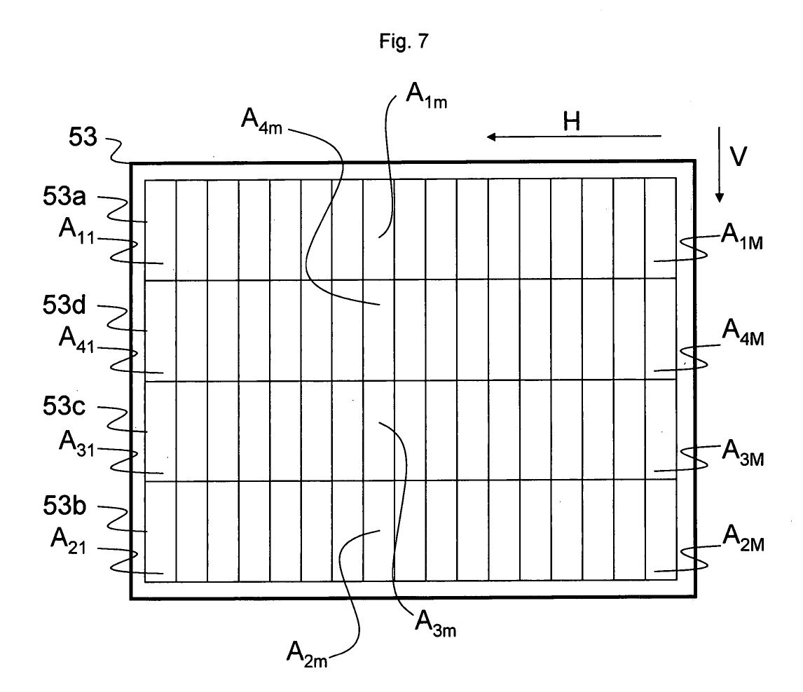

In the second direction, the length of the eighth-color cell group 53a, the length of the ninth-color cell group 53b, the length of the tenth-color cell group 53c, and the length of the eleventh-color cell group 53d are the same, similar to the first embodiment (see FIG. 7).

The eighth-color cell group 53a, the eleventh-color cell group 53d, the tenth-color cell group 53c, and the ninth-color cell group 53b are arranged in this order in the second direction. The eleventh-color cell group 53d is arranged in the vicinity of the middle of the third color chart 53, with regard to the second direction.

The third color chart 53 is imaged by the color scope 10, similar to the first color chart 51. The imaging conditions, and the process by which the result of imaging is output to the color printer 30 and the color monitor 40, is the same as that used for the first color chart 51.

The brightness of image obtained by the color scope 10, decreases in accordance with the distance from the light axis of the image optical system, due to the characteristics of the image optical system of the color scope 10 and the cos⁴ law.

Because each color cell of the eleventh-color cell group 53d consists of black and white, when the influence of a decrease in light quantity is big, it is more difficult to carry out the darkness, brightness, sharpness, and gamma adjustments P1, P2, P3, and P4, than to carry out the red, green, and blue adjustments Pr, Pg, and Pb.

The eleventh-color cell group 53d is able to be imaged without being influenced by the decrease in light quantity, in the third embodiment.

Further, even when the third color chart 53 is imaged after rotating by 90 degrees, the eleventh-color cell group 53d is arranged in the center vicinity. Accordingly, the eleventh-color cell group 53d is easily seen.

In this way, it is possible to carry out the color adjustment of the color printer 30 and the color monitor 40 of the endoscope in detail and objectively, by adjusting the seven color adjustment parameters Pr, Pg, Pb, P1, P2, P3, and P4.

Next, the fourth embodiment of the present invention will be explained. The structure of the endoscope is identical to that in the third embodiment. Each component in the color scope 10, the color processing unit 20, the color printer 30, and the color monitor 40 is identical to that in the third embodiment. Only the construction of the color chart is dissimilar to that in the third embodiment.

In the fourth embodiment, a fourth color chart 54 is used for the color adjustment the color printer 30 and the color monitor 40, instead of the third color chart 53.

The fourth color chart 54 has twelfth-, thirteenth-, fourteenth-, and fifteenth-color cell groups 54a, 54b, 54c, and 54d.

Each color cell which forms the twelfth-color cell group 54a is similar to each color cell which forms the eighth-color cell group 53a in the third embodiment. Accordingly, the gradation of color of the twelfth-color cell group 54a is the same as that of the eighth-color cell group 53a in the third embodiment.

Each color cell which forms the thirteenth-color cell group 54b is similar to each color cell which forms the ninth-color cell group 53b in the third embodiment. Accordingly, the gradation of color of the thirteenth-color cell group 54b is the same as that of the ninth-color cell group 53b in the third embodiment.

Each color cell which forms the fourteenth-color cell group 54c is similar to each color cell which forms the tenth-color cell group 53c in the third embodiment. Accordingly, the gradation of color of the fourteenth-color cell group 54c is the same as that of the tenth-color cell group 53c in the third embodiment.

Each color cell which forms the fifteenth-color cell group 54d is similar to each color cell which forms the eleventh-color cell group 53d in the third embodiment. Accordingly, the gradation of color of the fifteenth-color cell group 54d is the same as that of the eleventh-color cell 39. group 53d in the third embodiment.

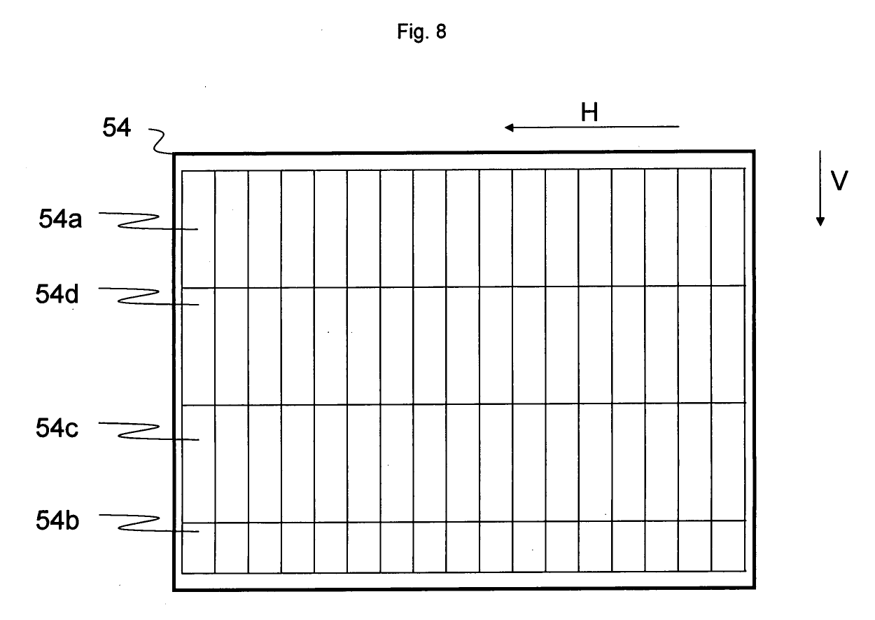

The length of the twelfth-color cell group 54a, the length of the fourteenth-color cell group 54c, and the length of the fifteenth-color cell group 54d, in the second direction, are the same, and the length of the twelfth-color cell group 54a is longer than that of the thirteenth-color cell group 54b (see FIG. 8).

Accordingly, the twelfth-color cell group 54a is larger than the eighth-color cell group 53a in the third embodiment. Similarly, the fourteenth-color cell group 54c is larger than the tenth-color cell group 53c in the third embodiment. Similarly, the fifteenth-color cell group 54d is larger than the eleventh-color cell group 53d in the third embodiment.

The twelfth-color cell group 54a, the fifteenth-color cell group 54d, the fourteenth-color cell group 54c, and the thirteenth-color cell group 54b are arranged in this order in the second direction, in a similar way to the third embodiment. The fifteenth-color cell group 54d is arranged in the vicinity of the middle of the fourth color chart 54 in the second direction.

The fourth color chart 54 is imaged by the color scope 10, similar to the third color chart 53. The imaging conditions, and the process by which the result of imaging is output to the color printer 30 and the color monitor 40, is the same as that used for the third color chart 53.

The fifteenth-color cell group 54d is able to be imaged without being influenced by the decrease in light quantity in the fourth embodiment.

In this way, it is possible to carry out the color adjustment of the color printer 30 and the color monitor 40 of the endoscope in detail and objectively, by adjusting the seven color adjustment parameters Pr, Pg, Pb, P1, P2, P3, and P4.

Next, the fifth embodiment of the present invention will be explained. The structure of the endoscope is identical to that in the third embodiment. Each component in the color scope 10, the color processing unit 20, the color printer 30, and the color monitor 40 is identical to that in the third embodiment. Only the construction of the color chart is dissimilar to that in the third embodiment.

In the fifth embodiment, a fifth color chart 55 is used for the color adjustment of the color printer 30 and the color monitor 40, instead of the third color chart 53.

The fifth color chart 55 has sixteenth-, seventeenth-, eighteenth-, and nineteenth-color cell groups 55a, 55b, 55c, and 55d.

Each color cell which forms the sixteenth-color cell group 55a is similar to each color cell which forms the eighth-color cell group 53a in the third embodiment. Accordingly, the gradation of color of the sixteenth-color cell group 55a is the same as that of the eighth-color cell group 53a in the third embodiment.

Each color cell which forms the seventeenth-color cell group 55b is similar to each color cell which forms the ninth-color cell group 53b in the third embodiment. Accordingly, the gradation of color of the seventeenth-color cell group 55b is the same as that of the ninth-color cell group 53b in the third embodiment.

Each color cell which forms the eighteenth-color cell group 55c is similar to each color cell which forms the tenth-color cell group 53c in the third embodiment. Accordingly, the gradation of color of the eighteenth-color cell group 55c is the same as that of the tenth-color cell group 53c in the third embodiment.

Each color cell which forms the nineteenth-color cell group 55d is similar to each color cell which forms the eleventh-color cell group 53d in the third embodiment. Accordingly, the gradation of color of the nineteenth-color cell group 55d is the same as that of the eleventh-color cell group 53d in the third embodiment.

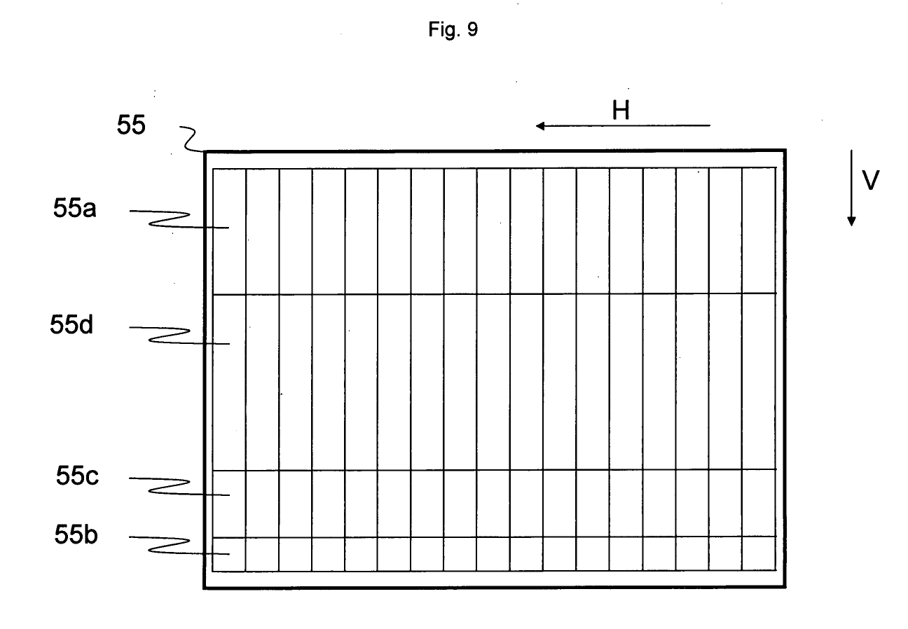

In the second direction, the length of the nineteenth-color cell group 55d is longer than the length of the sixteenth-color cell group 55a, the length of the sixteenth-color cell group 55a is longer than the length of the eighteenth-color cell group 55c, and the length of the eighteenth-color cell group 55c is longer than the length of the seventeenth-color cell group 55b (see FIG. 9).

Accordingly, the nineteenth-color cell group 55d is larger than the sixteenth-color cell group 55a. The sixteenth-color cell group 55a is larger than the eighteenth-color cell group 55c. The eighteenth-color cell group 55c is larger than the seventeenth-color cell group 55b.

The fifth color chart 55 is useful in the case where the priority given to adjust the darkness, brightness, sharpness, and gamma adjustment parameters P1, P2, P3, and P4 in one is higher than the priority given to adjust the red adjustment parameter Pr, the priority given to adjust the red adjustment parameter Pr is higher than the priority given to adjust the blue adjustment parameter Pb, and the priority given to adjust the blue adjustment parameter Pb is higher than the priority given to adjust the green adjustment parameter Pg for the color adjustment.

The sixteenth-color cell group 55a, the nineteenth-color cell group 55d, the eighteenth-color cell group 55c, and the seventeenth-color cell group 55b are arranged in this order in the second direction, similar to the third embodiment. The nineteenth-color cell group 55d is arranged in the vicinity of the middle of the fifth color chart 55, in the second direction.

The fifth color chart 55 is imaged by the color scope 10, similar to the third color chart 53. The imaging conditions, and the process by which the result of imaging is output to the color printer 30 and the color monitor 40, is the same as that used for the third color chart 53.

The nineteenth-color cell group 55d is able to be imaged without being influenced by the decrease in light quantity, in the fifth embodiment.

In this way, it is possible to carry out the color adjustment of the color printer 30 and the color monitor 40 of the endoscope in detail and objectively, by adjusting the seven color adjustment parameters Pr, Pg, Pb, P1, P2, P3, and P4.

Further, as long as each color cell which forms the first-color cell group 51a, is the same form, it is not limited to the rectangular form. Similarly, each color cell which forms the second-color cell group 51b is not limited to the rectangular form. Similarly, each color cell which forms the third-color cell group 51c is not limited to the rectangular form. Similarly, each color cell which forms the fourth-color cell group 51d is not limited to the rectangular form.

The second, third, fourth, and fifth color charts 52, 53, 54, and 55 in the second, third, fourth, and fifth embodiments are similar.

The arrangement of the color cell groups 51a, 51b, 51c, and 51d, is not limited to that in the first embodiment. For example, the groups may be arranged in the order of the adjustment items of the adjusting screen pattern 34, in the first embodiment. In this case, the location of the color cell group of the color chart which is observed corresponds to the location of the adjustment parameter on the adjusting screen pattern 34, so that it becomes easy to carry out the color adjustment.

The outer layers of the first-, second-, third-, and fourth-color cell groups 51a, 51b, 51c, and 51d may not have the same length in the first direction.

The first, second, third, and fourth predetermined number of cells in a group do not have to be the same. Further, the first predetermined number of cells in a group may be set in accordance with a number of adjusting levels of the adjusting screen pattern 34.

The second, third, fourth, and fifth color charts 52, 53, 54, and 55 in the second, third, fourth, and fifth embodiments are similar.

Further, the color adjustment apparatus 31 does not have to be included in the color printer 30. The color adjustment apparatus 31 may be a different body or structure that is connected with the color printer 30 and is able carry out the color adjustment of the color printer 30.

Also, the color adjustment apparatus 31 does not have to have a color adjustment indication function. The color monitor 40, can function as the adjustment indication unit 33. In this case, the color adjustment apparatus 31 has direction keys 32a-32d, the decision key 34e, the first adjusting screen pattern 34, and the second screen pattern 35 etc. Also, the color adjustment apparatus 31 has a function for indicating the first adjusting screen pattern 34 etc. on the color monitor 40.

The value of the ratio of each color cell does not have to be the same as in these embodiments. Accordingly, a gradation according to other ratios may be used.

The colors of the color cells that form the color chart are prepared by blending red, green, and blue, which are the three primaries, according to a predetermined ratio, in an additive color process. However, the color may be prepared by blending yellow, magenta, and cyan which are the alternative three primaries, according to a predetermined ratio, in a subtractive color process. In this situation, each adjustment parameter value is changed.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Applications Nos. 2003-202256 (filed on Jul. 28, 2003) and 2003-363663 (filed on Oct. 23, 2003), which are expressly incorporated herein by reference, in their entirety.

1. A color chart for a color adjustment of a color printer and a color monitor attached to an endoscope, said color chart comprising:
a first-color cell group, a second-color cell group, and a third-color cell group, each of said color cell groups having respective first, second, and third predetermined numbers of color cells having the same form, said color cells within each of said color cell groups being linearly arranged in a first direction;
said first-color cell group, second-color cell group, and third-color cell group being arranged in a second direction which is perpendicular to said first direction;
each of said color cells, which form said first-color cell group, said second-color cell group, and said third-color cell group, being formed by blending three colors comprising red, green, and blue, according to predetermined ratios in an additive color process, and showing a gradation of color such that a ratio of one of said colors in each of said color cells increases continuously in said first direction within each said color cell group, and ratios of the respective remaining two of said colors in each of said color cells, within each said color cell group, decrease continuously and in the same proportion in said first direction.

2. The color chart according to claim 1, wherein said first, second, and third-color cell groups are arranged in the order of said first-color cell group, said second-color cell group, and said third-color cell group.

3. The color chart according to claim 1, wherein a first length of said first-color cell group in said first direction, a second length of said second-color cell group in said first direction, and a third length of said third-color cell group in said first direction are the same.

4. The color chart according to claim 1, wherein a fourth length of said first-color cell group in said second direction, a fifth length of said second-color cell group in said second direction, and a sixth length of said third-color cell group in said second direction are the same.

5. The color chart according to claim 1, wherein said first predetermined number of color cells, said second predetermined number of color cells, and said third predetermined number of color cells are the same.

6. The color chart according to claim 1, wherein said first predetermined number of color cells, said second predetermined number of color cells, and said third predetermined number of color cells are an odd number; and
color cells which are arranged in a middle in said first-, second-, and third-color cell groups are gray, comprising red 50%, green 50%, and blue 50%.

7. The color chart according to claim 1, wherein; said first-color cell group has a first side cell which is arranged at one side of said first-color cell group, and a second side cell which is arranged at another side of said first-color cell group;
said second-color cell group has a third side cell which is arranged at said one side of said second-color cell group, and a fourth side cell which is arranged at said another side of said second-color cell group; and
said third-color cell group has a fifth side cell which is arranged at said one side of said third-color cell group, and a sixth side cell which at arranged in said another side of said third-color cell group;
said first side cell having red 0%, green 100%, and blue 100%;
said second side cell having red 100%, green 0%, and blue 0%;
said third side cell having red 100%, green 0%, and blue 100%;
said fourth side cell having red 0%, green 100%, and blue 0%;
said fifth side cell having red 100%, green 100%, and blue 0%; and
said sixth side cell having red 0%, green 0%, blue 100%.

8. The color chart according to claim 1, wherein an order of placement of said first-color cell group, said second-color cell group, and said third-color cell group, in said second direction, is based on the priority given to said first, second, and third-color cell groups in said color adjustment.

9. The color chart according to claim 8, wherein said order of priority is, said first and third-color cell groups, followed by said second-color cell group.

10. The color chart according to claim 1, wherein; said color monitor is able to indicate an adjusting screen pattern for said color adjustment;
said adjusting screen pattern shows first, second, and third adjustment items, and red, green, and blue adjustment parameters;
said red adjustment parameter being for the adjustment of the cyan and red complementary color relationship, in accordance with said first adjustment item;
said green adjustment parameter being for the adjustment of the magenta and green complementary color relationship, in accordance with said second adjustment item; and
said blue adjustment parameter being for the adjustment of the yellow and blue complementary color relationship, in accordance with said third adjustment item;
said first-, second-, and third-color cell groups being arranged in the same order as said first, second, and third adjustment items in said adjusting screen pattern.

11. The color chart according to claim 1, wherein said color monitor is able to indicate an adjusting screen pattern for said color adjustment;
said adjusting screen pattern showing red, green, and blue adjustment parameters;
said red adjustment parameter being for the adjustment of the cyan and red complementary color relationship;
said green adjustment parameter being for the adjustment of the magenta and green complementary color relationship;
said blue adjustment parameter being for the adjustment of the yellow and blue complementary color relationship;
said first predetermined number of color cells being set in accordance with a number of adjusting levels of said red adjustment parameter on said adjusting screen pattern;
said second predetermined number of color cells being set in accordance with a number of adjusting levels of said green adjustment parameter on said adjusting screen pattern; and
said third predetermined number of color cells being set in accordance with a number of adjusting levels of said blue adjustment parameter on said-adjusting screen pattern.

12. A method using a color chart for the color adjustment of a color printer and a color monitor attached to an endoscope, said color printer outputting a first image of said color chart obtained by said endoscope, said color monitor outputting a second image of said color chart obtained by said endoscope, said color chart comprising a first-color cell group, a second-color cell group, and a third-color cell group, each of said color cell groups having respective first, second, and third predetermined numbers of color cells having the same form, said color cells within each of said color cell groups being linearly arranged in a first direction, said first-color cell group, second-color cell group, and third-color cell group being arranged in a second direction which is perpendicular to said first direction, each of said color cells, which form said first-color cell group, said second-color cell group, and said third-color cell group, being formed by blending three colors comprising red, green, and blue, according to predetermined ratios, in an additive color process, and showing a gradation of color such that a ratio of one of said colors in each of said color cells increases continuously in said first direction within each said color cell group, and ratios of the respective remaining two of said colors in each of said color cells, within each said color cell group, decrease continuously and in the same proportion in said first direction, said method comprising:
a comparison of said first image with said second image; and
at least one adjustment of a complementary color relationship, in three adjustment operations, said adjustment operations comprising the adjustment of the cyan and red complementary color relationship, the adjustment of the magenta and green complementary color relationship, and the adjustment of the yellow and blue complementary color relationship.

13. An endoscope system comprising:
a color chart which has a first-color cell group, a second-color cell group, and a third-color cell group, each of said color cell groups having respective first, second, and third predetermined numbers of color cells having the same form, said color cells within each of said color cell groups being linearly arranged in a first direction, said first-color cell group, second-color cell group, and third-color cell group being arranged in a second direction which is perpendicular to said first direction, each of said color cells, which form said first-color cell group, said second-color cell group, and said third-color cell group, being formed by blending three colors comprising red, green, and blue, according to predetermined ratios, in an additive color process, and showing a gradation of color such that a ratio of one said colors in each of said color cells increases continuously in said first direction within each said color cell group, and ratios of the respective remaining two of said colors in each of said color cells, within each said color cell group, decrease continuously and in the same proportion in said first direction;
said endoscope which images said color chart;
said color printer which outputs a first image of said color chart obtained by said endoscope;
said color monitor which outputs a second image of said color chart obtained by said endoscope;
said color adjustment apparatus which is used for the color adjustment of said color printer and said color monitor;
said color adjustment being carried out on basis of:
a comparison of said first image with said second image; and
at least one adjustment of a complementary color relationship, in three adjustment operations, said adjustment operations comprising the adjustment of the cyan and red complementary color relationship, the adjustment of the magenta and green complementary color relationship, and the adjustment of the yellow and blue complementary color relationship.

14. A color chart for a color adjustment of a color printer and a color monitor attached to an endoscope, said second color chart comprising:
a first-color cell group, a second-color cell group, a third-color cell group, and a fourth-color cell group, each of said color cell groups having respective first, second, third, and fourth predetermined numbers of color cells having the same form, said color cells within each of said color cell groups being linearly arranged in a first direction;
said first-color cell group, second-color cell group, third-color cell group, and fourth-color cell group being arranged in a second direction which is perpendicular to said first direction;
each of said color cells, which form said first-color cell group, said second-color cell group, and said third-color cell group, being formed by blending three colors comprising red, green, and blue, according to predetermined ratios, in an additive color process, and showing a gradation of color such that a ratio of one of said colors in each of said color cells increases continuously in said first direction within each said color cell group, and ratios of the respective remaining two of said colors in each of said color cells, within each said color cell group, decrease continuously and in the same proportion in said first direction; and
each of said color cells, which form said fourth-color cell group, being formed by blending three colors comprising red, green, and blue, according to a predetermined ratio, and showing a gradation of color such that red, green, and blue ratios of each of said color cells increase continuously and in the same proportion in said first direction.

15. The color chart according to claim 14, wherein said fourth-color cell group is arranged in the middle of the said second color chart, in said second direction.

16. The color chart according to claim 15, wherein a color cell which is arranged in the middle of said fourth-color cell group is gray comprising red 50%, green 50%, and blue 50%.

17. The color chart according to claim 14, wherein said first-, second-, third-, and fourth-color cell groups are arranged in the order of said first-color cell group, said fourth-color cell group, said third-color cell group, and said second-color cell group.

18. The color chart according to claim 14, wherein a first length of said first-color cell group in said first direction, a second length of said second-color cell group in said first direction, a third length of said third-color cell group in said first direction, and a fourth length of said fourth-color cell group in said first direction are the same.

19. The color chart according to claim 14, wherein said first predetermined number of color cells, said second predetermined number of color cells, said third predetermined number of color cells, and said fourth predetermined number of color cells are the same.

20. The color chart according to claim 14, wherein said first predetermined number of color cells, said second predetermined number of color cells, said third predetermined number of color cells, and said fourth predetermined number of color cells are an odd number; and
color cells which are arranged in a middle of each of said first-, second-, third-, and fourth-color cell groups are gray, comprising red 50%, green 50%, and blue 50%.

21. The color chart according to claim 14, wherein; said first-color cell group has a first side cell which is arranged at one side of said first-color cell group, and a second side cell which is arranged at another side of said first-color cell group;
said second-color cell group has a third side cell which is arranged at said one side of said second-color cell group, and a fourth side cell which is arranged at said another side of said second-color cell group;
said third-color cell group has a fifth side cell which is arranged at said one side of said third-color cell group, and a sixth side cell which is arranged at said another side of said third-color cell group; and
said fourth-color cell group has a seventh side cell which is arranged at said one side of said fourth-color cell group, and a eighth side cell which is arranged at said another side of said fourth-color cell group;
said first side cell having red 0%, green 100%, and blue 100%;
said second side cell having red 100%, green 0%, and blue 0%;
said third side cell having red 100%, green 0%, and blue 100%;
said fourth side cell having red 0%, green 100%, and blue 0%;
said fifth side cell having red 100%, green 100%, and blue 0%;
said sixth side cell having red 0%, green 0%, blue 100%;
said seventh side cell having red 0%, green 0%, blue 0%; and
said eighth side cell having red 100%, green 100%, blue 100%.

22. The color chart according to claim 14, wherein an order of placement of said first-color cell group, said second-color cell group, said third-color cell group, and said fourth-color cell group, in said second direction, is based on the priority given to said first-, second-, third-, and fourth-color cell groups in said color adjustment.

23. The color chart according to claim 22, wherein said order of priority is, said fourth-color cell group, said first-color cell group, said third-color cell group, and said second-color cell group.

24. The color chart according to claim 14, wherein; said color monitor is able to indicate an adjusting screen pattern for said color adjustment; and
said adjusting screen pattern shows first, second, third, fourth adjustment items, red, green, and blue adjustment parameters, and one adjustment parameter for darkness, brightness, sharpness, and gamma adjustment parameters;
said red adjustment parameter being for the adjustment of the cyan and red complementary color relationship, in accordance with said first adjustment item;
said green adjustment parameter being for the adjustment of the magenta and green complementary color relationship, in accordance with said second adjustment item;
said blue adjustment parameter being for the adjustment of the yellow and blue complementary color relationship, in accordance with said third adjustment item;
said one adjustment parameter being for the adjustment of a contrast of shadows, or a contrast of highlights, or an image quality, or a gamma correction; and
said first-, second-, third-, and fourth-color cell groups being arranged in the same order as said first, second, third, and fourth adjustment items in said adjusting screen pattern.

25. The second color chart according to claim 14, wherein; said color monitor is able to indicate an adjusting screen pattern for said color adjustment; and
said adjusting screen pattern shows red, green, and blue parameters, and one adjustment parameter for darkness, brightness, sharpness, and gamma correction;
said red adjustment parameter being for the adjustment of the cyan and red complementary color relationship;
said green adjustment parameter being for the adjustment of the magenta and green complementary color relationship;
said blue adjustment parameter being for the adjustment of the yellow and blue complementary color relationship;
said one adjustment parameter being for the adjustment of one of a contrast of shadows, a contrast of highlights, an image quality, and a gamma correction;
said first predetermined number of color cells being set in accordance with a number of adjusting levels of said red adjustment parameter on said adjusting screen pattern;
said second predetermined number of color cells being set in accordance with a number of adjusting levels of said green adjustment parameter on said adjusting screen pattern;
said third predetermined number of color cells being set in accordance with a number of adjusting levels of said blue adjustment parameter on said adjusting screen pattern; and
said fourth predetermined number of color cells being set in accordance with a number of adjusting levels of said one adjustment parameter on said adjusting screen pattern.

26. A method using a color chart for the color adjustment of a color printer and a color monitor attached to an endoscope, said color printer outputting a first image of said color chart obtained by said endoscope, said color monitor outputting a second image of said color chart obtained by said endoscope, said color chart comprising a first-color cell group, a second-color cell group, a third-color cell group, and a fourth-color cell group, each of said color cell groups having respective first, second, third, and fourth predetermined numbers of color cells having the same form, said color cells within each of said color cell groups being linearly arranged in a first direction, said first-color cell group, second-color cell group, third-cell group, and fourth-color cell group being arranged in a second direction which is perpendicular to said first direction, each of said color cells, which form said first-color cell group, said second-color cell group, and said third-color cell group, being formed by blending three colors comprising red, green, and blue, according to predetermined ratios, in an additive color process, and showing a gradation of color such that a ratio of one of said colors in each of said color cells increases continuously in said first direction within each said color cell group, and ratios of the respective remaining two of said colors in each of said color cells, within each said color cell group, decrease continuously and in the same proportion in said first direction, and each of said color cells, which form said fourth-color cell group, being formed by blending three colors comprising red, green, and blue, according to a predetermined ratio, and showing a gradation of color such that red, green, and blue ratios of each of said color cells increase continuously and in the same proportion in said first direction, said method comprising:
a comparison of said first image with said second image; and
at least one adjustment of a complementary color relationship, in seven adjustment operations, said adjustment operations comprising the adjustment of the cyan and red complementary color relationship, the adjustment of the magenta and green complementary color relationship, the adjustment of the yellow and blue complementary color relationship, adjustment of the contrast of shadows, the adjustment of the contrast of highlights, the adjustment of image quality, and the gamma correction.

27. An endoscope system comprising:
a color chart which has a first-color cell group, a second-color cell group, a third-color cell group, and a fourth-color cell group, each of said color cell groups having respective first, second, third, and fourth predetermined numbers of color cells having the same form, said color cells within each of said color cell groups being linearly arranged in a first direction, said first-color cell group, second-color cell group, third-color cell group, and fourth-color cell group being arranged in a second direction which is perpendicular to said first direction, each of said color cells, which form said first-color cell group, said second-color cell group, and said third-color cell group, being formed by blending three colors comprising red, green, and blue, according to predetermined ratios, in an additive color process, and showing a gradation of color such that a ratio of one of said colors in each of said color cells increases continuously in said first direction within each said color cell group, and ratios of the respective remaining two of said colors in each of said color cells, within each said color cell group, decrease continuously and in the same proportion in said first direction and each of said color cells, which form said fourth-color cell group, being formed by blending three colors comprising red, green, and blue, according to a predetermined ratio, and showing a gradation of color such that red, green, and blue ratios of each of said color cells increase continuously and in the same proportion in said first direction;
said endoscope which images said color chart;
said color printer which outputs a first image of said color chart obtained by said endoscope;
said color monitor which outputs a second image of said color chart obtained by said endoscope;
said color adjustment apparatus which is used for the color adjustment of said color printer and said color monitor;
said color adjustment being carried out on basis of:
a comparison of said first image with said second image; and
at least one adjustment of a complementary color relationship, in seven adjustment operations, said adjustment operations comprising the adjustment of the cyan and red complementary color relationship, the adjustment of the magenta and green complementary color relationship, the adjustment of the yellow and blue complementary color relationship, the adjustment of the contrast of shadows, the adjustment of the contrast of highlights, the adjustment of image quality, and the gamma correction.
